(19) United States
(12) Patent Application Publication
(10) Pub. No.: US 2013/0149155 A1
(43) Pub. Date: Jun. 13, 2013

(54) ROTOR SHAFT AND COOLING FAN USING SAME

(71) Applicants: Bor-Haw Chang, New Taipei City (TW); Shu-Fan Liu, New Taipei City (TW)

(72) Inventors: Bor-Haw Chang, New Taipei City (TW); Shu-Fan Liu, New Taipei City (TW)

(73) Assignee: ASIA VITAL COMPONENTS CO., LTD., New Taipei City (TW)

(21) Appl. No.: 13/314,113

(22) Filed: Dec. 7, 2011

(51) Int. Cl. F04D 29/04; F16C 3/02

(52) U.S. Cl. 416/174; 464/179

(57) ABSTRACT

A rotor shaft includes a main body having a central portion and an extension portion. The extension portion has a plurality of extension sections radially outward extended from the central portion by different distances to together define a peripheral surface and a non-circular cross section of the main body. In a cooling fan using the rotor shaft, the main body of the rotor shaft is received in a shaft space internally defined by a bearing of the fan, and a lubricant is filled in a space left between the main body and the shaft space. With the non-circular cross section of the main body of the rotor shaft, the lubricant filled between the rotor shaft and the shaft space can have increased support pressure to thereby reduce the noise and vibration caused by frictional contact of the rotor shaft with the bearing during the operation of the cooling fan.

### FIELD OF THE INVENTION

The present invention relates to a rotor shaft, and more particularly to a rotor shaft having a non-circular cross section. The present invention also relates to a cooling fan using the non-circular rotor shaft, so that a lubricant filled between the rotor shaft and a bearing of the cooling fan can have increased support pressure.

### BACKGROUND OF THE INVENTION

Various kinds of electronic information products, such as computers and the like, are now very popular among people and applied to very wide applications. Due to consumers' demands, the electronic information technology has quickly developed and it has become a significant trend to increase the computing speed and the access capacity of the electronic information products. However, a high amount of heat is also produced when the elements of the electronic information products operate at high speed.

For example, the central processing unit (CPU) of a computer produces the largest part of heat in the computer. When the produced heat gradually increases and accumulates in the computer, it would bring the CPU to have lowered performance. And, when the accumulated heat exceeds the allowable upper limit, it would force the computer to crash or even cause burnout of the computer. Moreover, to solve the problem of electromagnetic wave radiation, most of the important and heat-producing components of the computer are enclosed in a metal case. Thus, it is an important issue as how to quickly guide out and dissipate the heat energy produced by the CPU and other heat-producing elements.

A general way to solve the problem of heat dissipation for CPU is to mount a heat sink and a cooling fan atop the CPU. The heat sink is provided on one side with a plurality of radiating fins, and another opposite side of the heat sink without the radiating fin is in direct contact with the CPU, so that the heat produced by the CPU is transferred to the radiating fins, from where the heat is radiated into the ambient air. The cooling fan cooperates with the heat sink to produce air flows that force the heat to more quickly dissipate into the ambient environment.

The cooling fan includes a seat and a rotor assembly. The seat is formed with a bearing cup, in which at least one bearing is provided. A stator assembly is externally fitted around the bearing cup. The bearing internally defines a shaft space. The rotor assembly includes a hub and a rotor shaft. The hub has a plurality of spaced and radially outward extended blades. The rotor shaft has an end inserted into one side of the hub and another opposite end rotatably received in the shaft space. A lubricant is filled between the rotor shaft and the shaft space of the bearing. When the cooling fan operates, the rotor shaft of the rotor assembly rotates in and relative to the bearing. Since the lubricant provides uneven support pressure when the rotor shaft rotates, the rotor shaft would collide with an inner wall surface of the shaft space to produce noise and vibration, preventing the rotor assembly from operating smoothly. Under these circumstances, the cooling fan would have reduced service life.

### SUMMARY OF THE INVENTION

A primary object of the present invention is to provide a rotor shaft having a non-circular cross section, so as to reduce the noise, vibration and wearing occurred during the use of the rotor shaft.

Another object of the present invention is to provide a cooling fan that uses a rotor shaft having a non-circular cross section, so as to reduce the noise, vibration and wearing occurred during the operation of the cooling fan.

To achieve the above and other objects, the rotor shaft according to the present invention includes a main body having a central portion and an extension portion. The extension portion includes a plurality of extension sections, which are connected to one another and respectively radially outward extend from the central portion to together define a peripheral surface of the main body. The extension sections respectively radially outward extend from the central portion by a different distance.

To achieve the above and other objects, the cooling fan according to the present invention includes a seat having a bearing cup internally defining a receiving space, and the receiving space axially extending a full length of the bearing cup; a stator assembly being mounted around the bearing cup; a bearing internally defining a shaft space and being received in the receiving space of the bearing cup; a rotor assembly having a hub and a rotor shaft; the hub having a plurality of blades spaced thereon; the rotor shaft having an end inserted into one side of the hub and another opposite end rotatably received in the shaft space. The rotor shaft has a main body, which includes a central portion and an extension portion. The extension portion includes a plurality of extension sections, which are connected to one another and respectively radially outward extend from the central portion to together define a peripheral surface of the main body. The extension sections respectively radially outward extend from the central portion by a different distance. A lubricant is filled in a space left between the peripheral surface of the main body and the shaft space.

Since the rotor shaft according to the present invention has a non-circular cross section, the lubricant filled in the space left between the peripheral surface of the rotor shaft and the shaft space of the bearing of the cooling fan can have increased support pressure to avoid the occurrence of frictional wearing, noise, and vibration during the operation of the cooling fan, which in turn largely increases the service life of the cooling fan.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a first embodiment of a rotor shaft according to the present invention;

FIG. 2 is a perspective view of a second embodiment of the rotor shaft according to the present invention;

FIG. 3 is a perspective view of a third embodiment of the rotor shaft according to the present invention;

FIG. 4 is a perspective view of a fourth embodiment of the rotor shaft according to the present invention;

FIG. 5 is a perspective view of a fifth embodiment of the rotor shaft according to the present invention;

FIG. 6 is a perspective view of a sixth embodiment of the rotor shaft according to the present invention;

FIG. 7 is an exploded perspective view of a first embodiment of a cooling fan according to the present invention;

FIG. 8 is an assembled view of FIG. 7;

FIG. 9 is a sectional view taken along line A-A of FIG. 8;

FIG. 10 is an exploded perspective view of a second embodiment of the cooling fan according to the present invention;

FIG. 11 is an exploded perspective view of a third embodiment of the cooling fan according to the present invention;

FIG. 12 is an exploded perspective view of a fourth embodiment of the cooling fan according to the present invention; and

FIG. 13 is a sectional view taken along line B-B of FIG. 8.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

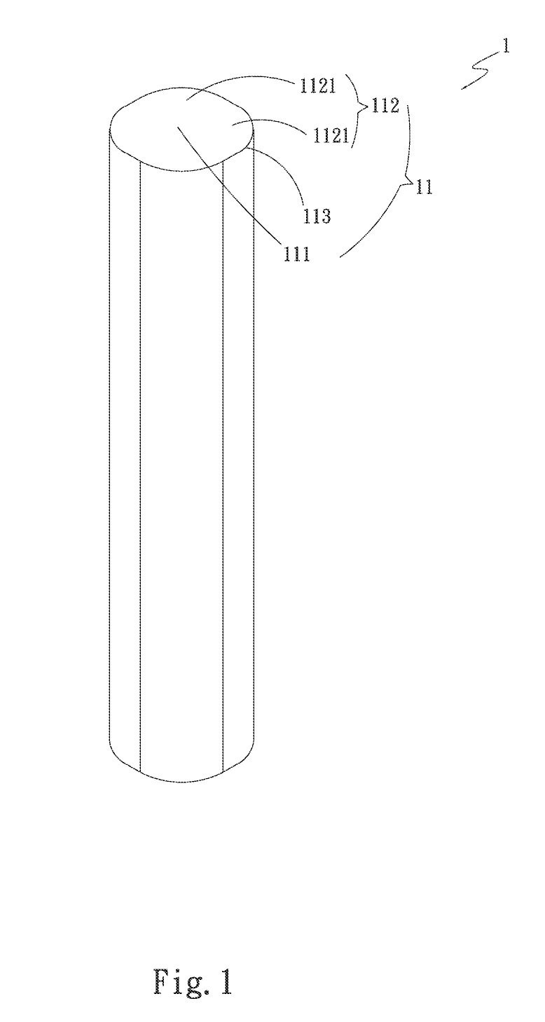

Please refer to FIG. 1 that is a perspective view of a first embodiment of a rotor shaft 1 according to the present invention. As shown, the rotor shaft 1 includes a main body 11.

The main body 11 has a central portion 111 and an extension portion 112. The extension portion 112 has a plurality of extension sections 1121 connected to one another. The extension sections 1121 respectively radially outward extend from the central portion 111 to together define a peripheral surface 113 of the main body 11. It is noted the extension sections 1121 respectively radially outward extend from the central portion 111 by a different distance, giving the main body 11 a non-circular cross section.

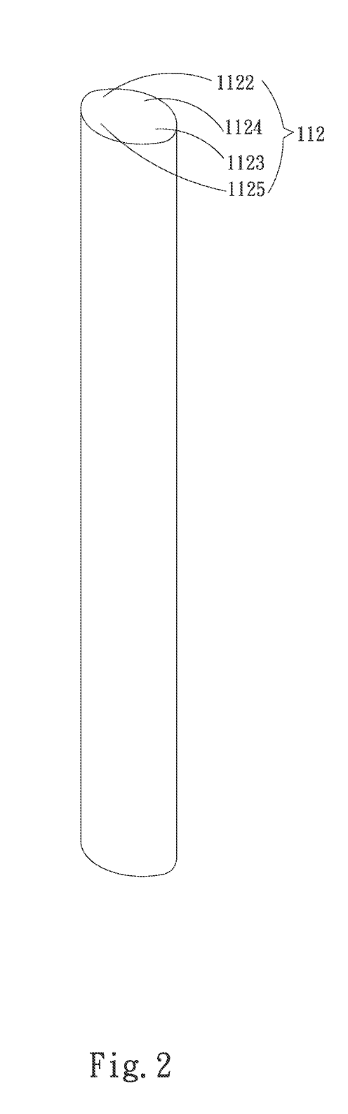

Please refer to FIG. 2 that is a perspective view of a second embodiment of the rotor shaft according to the present invention. As shown, the second embodiment is generally structurally similar to the first embodiment, except that, in the second embodiment, the extension portion 112 includes four extension sections, namely, a first extension section 1122, a second extension section 1123, a third extension section 1124, and a fourth extension section 1125. Wherein, the first and the second extension section 1122, 1123 are located diametrically opposite to each other, and the third and the fourth extension section 1124, 1125 are located diametrically opposite to each other. That is, the first extension section 1122 has two lateral sides adjoining to one lateral side of the third and of the fourth extension 1124, 1125, while the second extension section 1123 has two lateral sides adjoining to the other lateral side of the third and of the fourth extension 1124, 1125. And, the first to the fourth extension sections 1122, 1123, 1124, 1125 together give the main body 11 an elliptical cross section.

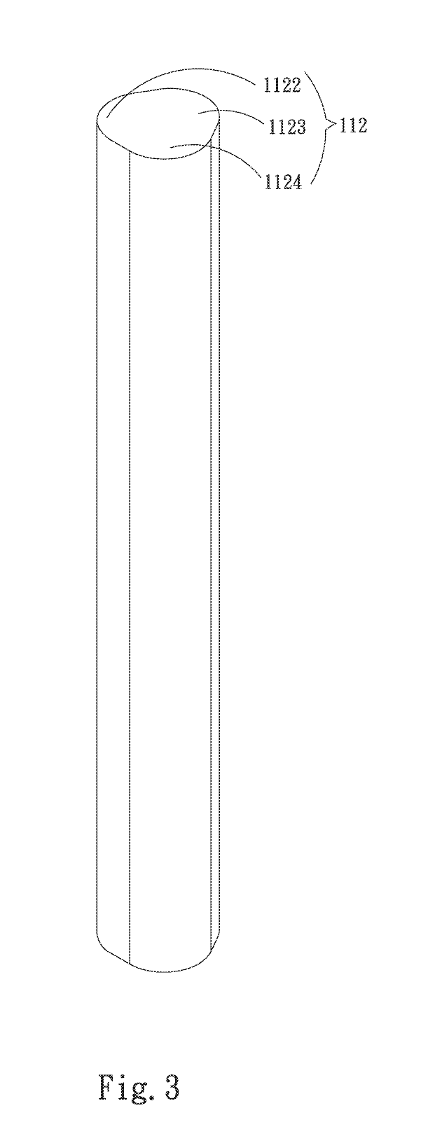

FIG. 3 is a perspective view of a third embodiment of the rotor shaft according to the present invention. As shown, the third embodiment is generally structurally similar to the first embodiment, except that, in the third embodiment, the extension portion 112 includes three extension sections, namely, a first extension section 1122, a second extension section 1123, and a third extension section 1124. Wherein, the first extension section 1122 has two lateral sides adjoining to the second and the third extension section 1123, 1124. And, the first to the third extension sections 1122, 1123, 1124 together give the main body 11 a rounded wedge-shaped cross section.

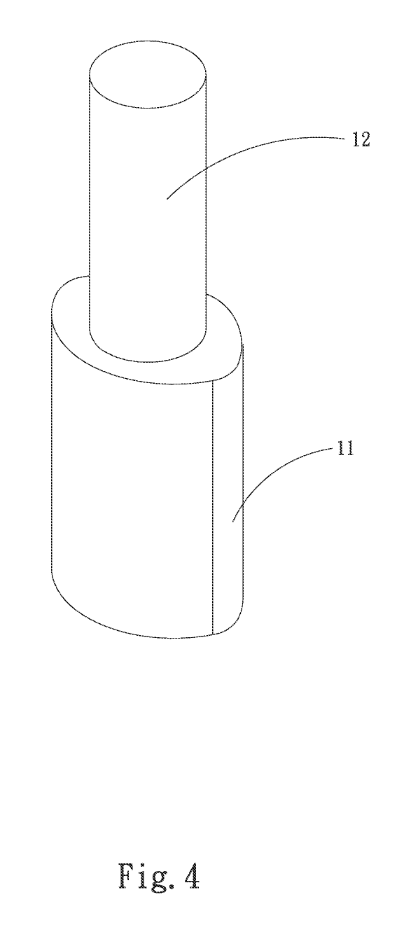

FIG. 4 is a perspective view of a fourth embodiment of the rotor shaft according to the present invention. As shown, the fourth embodiment is generally structurally similar to the first embodiment, except that, in the fourth embodiment, the main body 11 has a first extended end 12, which is axially extended from an end of the main body 11 and has a round cross section.

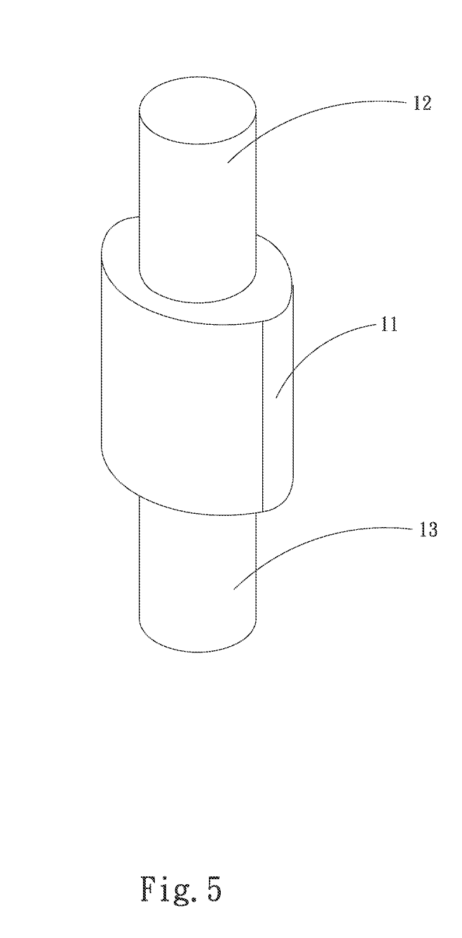

Please refer to FIG. 5 that is a perspective view of a fifth embodiment of the rotor shaft according to the present invention. As shown, the fifth embodiment is generally structurally similar to the first embodiment, except that, in the fifth embodiment, the main body 11 has a first extended end 12 and a second extended end 13, which are separately axially extended from two opposite ends of the main body 11 and both have a round cross section.

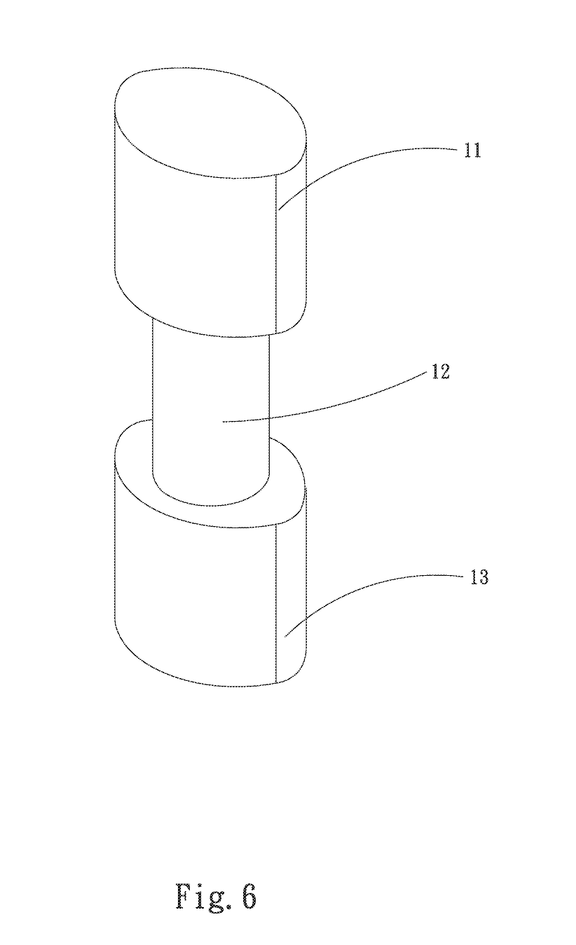

Please refer to FIG. 6 that is a perspective view of a sixth embodiment of the rotor shaft according to the present invention. As shown, the sixth embodiment is generally structurally similar to the first embodiment, except that, in the sixth embodiment, the main body 11 has a first extended end 12 and a second extended end 13. The first extended end 12 is axially extended from an end of the main body 11 and has a round cross section, and the second extended end 13 is axially extended from an end of the first extended end 12 opposite to the main body 11 and has a cross sectional shape the same as that of the main body 11.

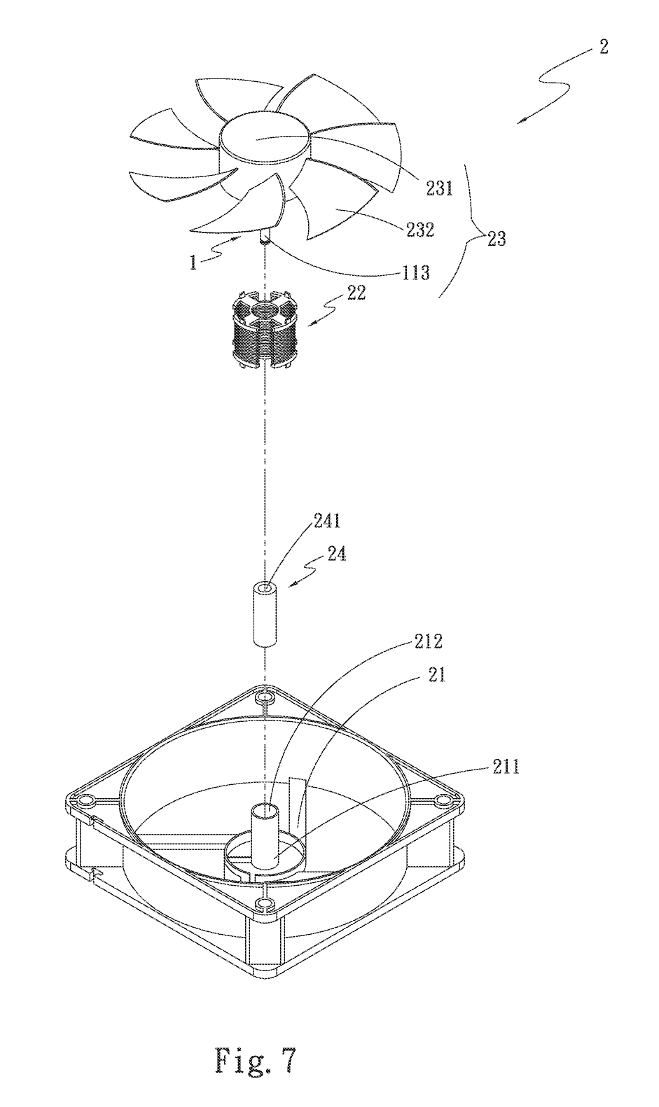

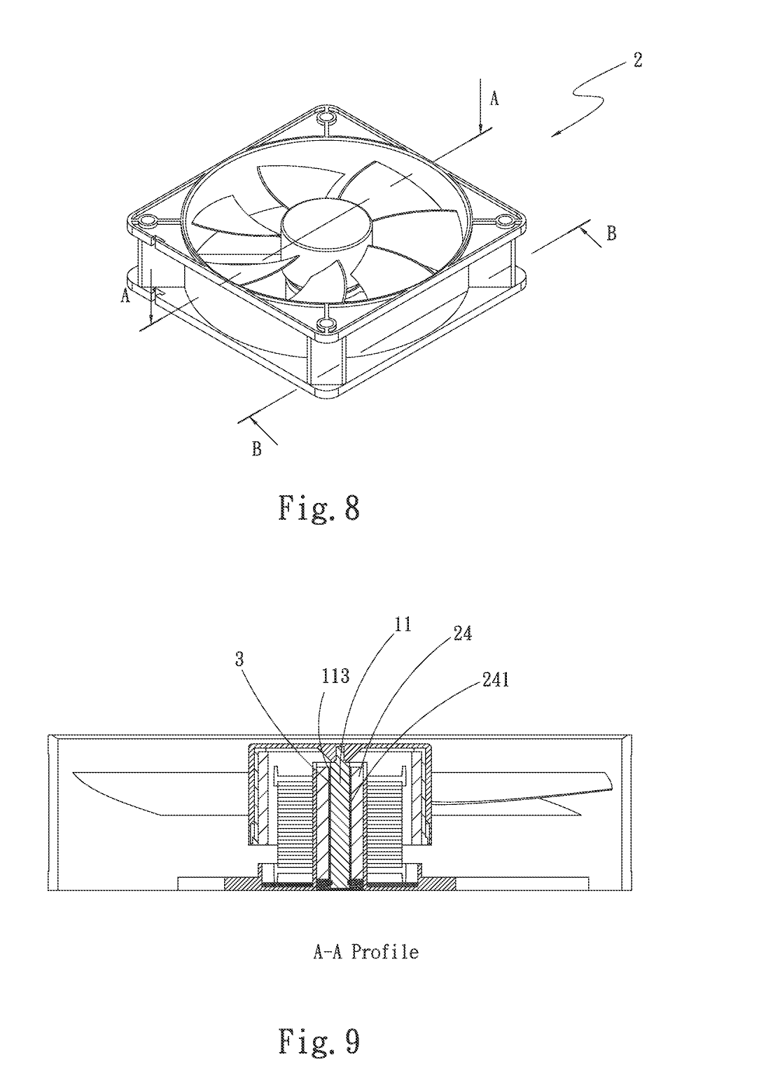

Please refer to FIGS. 7 and 8 that are exploded and assembled perspective views, respectively, of a first embodiment of a cooling fan 2 according to the present invention, and to FIG. 9 that is a sectional view taken along line A-A of FIG. 8. The cooling fan 2 includes a seat 21, a stator assembly 22, a rotor assembly 23, and a bearing 24. The seat 21 has a bearing cup 211, in which a receiving space 212 is defined. The receiving space 212 axially extends a full length of the bearing cup 211.

The stator assembly 22 is externally mounted around the bearing cup 211.

The bearing 24 internally defines a shaft space 241, and is mounted in the receiving space 212 of the bearing cup 211.

The rotor assembly 23 includes a hub 231 and a rotor shaft 1. The hub 231 has a plurality of spaced and radially outward extended blades 232. The rotor shaft 1 has an end fixedly inserted into one side of the hub 231 and another opposite end rotatably received in the shaft space 241. Since the rotor shaft 1 can be any one of the first to the sixth embodiments of the rotor shaft 1 as described above, it is not discussed in details herein. A lubricant 3 is filled in a space left between the peripheral surface 113 of the rotor shaft 1 and the shaft space 241.

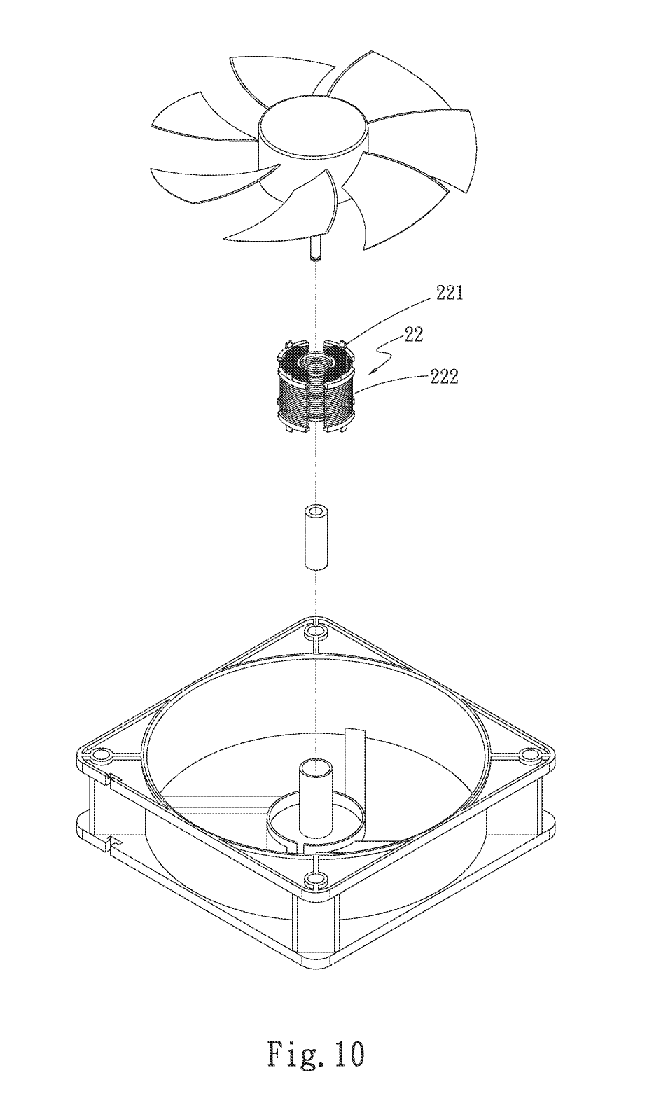

FIG. 10 is an exploded perspective view of a second embodiment of the cooling fan according to the present invention. As shown, the cooling fan in the second embodiment is generally structurally similar to the first embodiment, except that, in the second embodiment, the stator assembly 22 includes a plurality of coils 221 and at least one silicon steel plate, and the coils 221 are externally wound around the silicon steel plate 222.

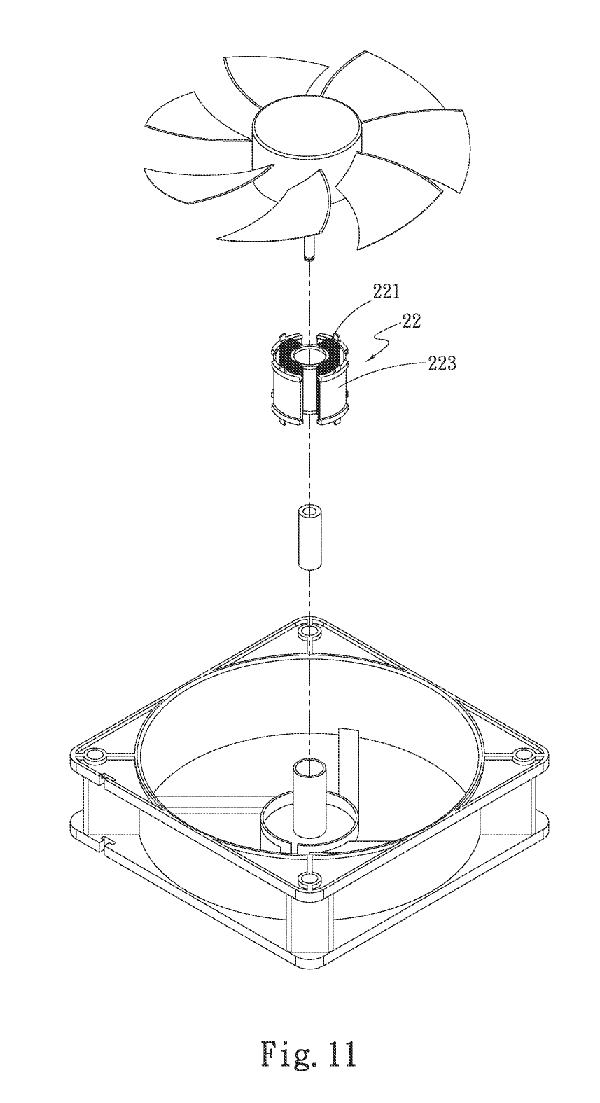

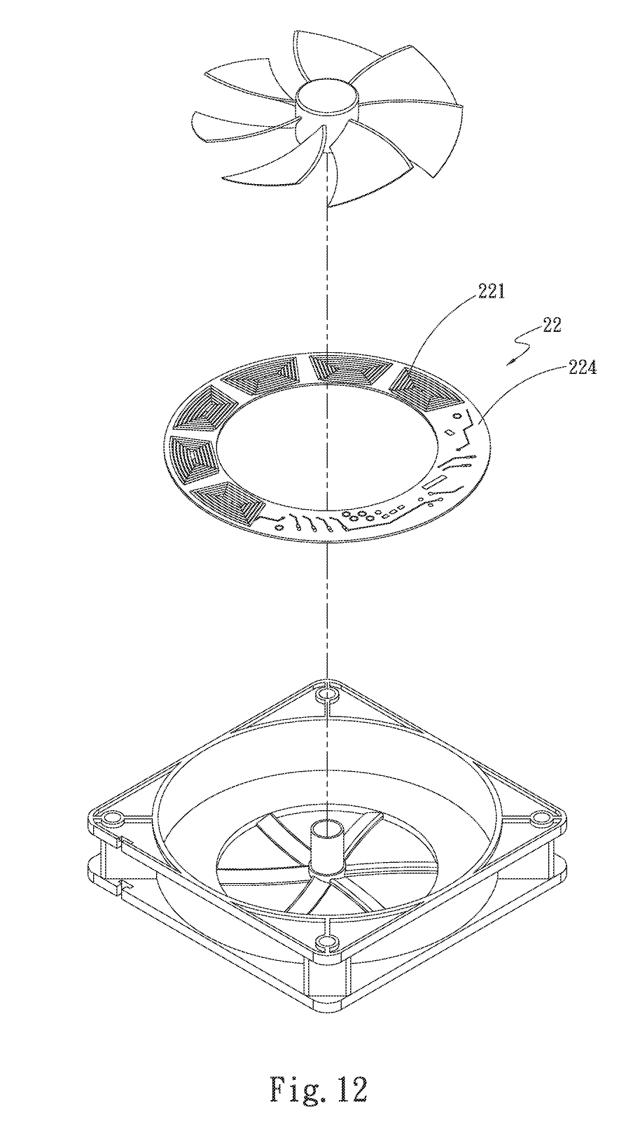

FIG. 11 is an exploded perspective view of a third embodiment of the cooling fan according to the present invention. As shown, the cooling fan in the third embodiment is generally structurally similar to the first embodiment, except that, in the third embodiment, the stator assembly 22 includes a plurality of coils 221 and a magnetizable metal member 223, and the coils 221 are externally wound around the magnetizable metal member 223.

FIG. 11 is an exploded perspective view of a fourth embodiment of the cooling fan according to the present invention. As shown, the cooling fan in the fourth embodiment is generally structurally similar to the first embodiment, except that, in the fourth embodiment, the stator assembly 22 includes a plurality of coils 221 and a circuit board 224, and the coils 221 are wound on the circuit board 224.

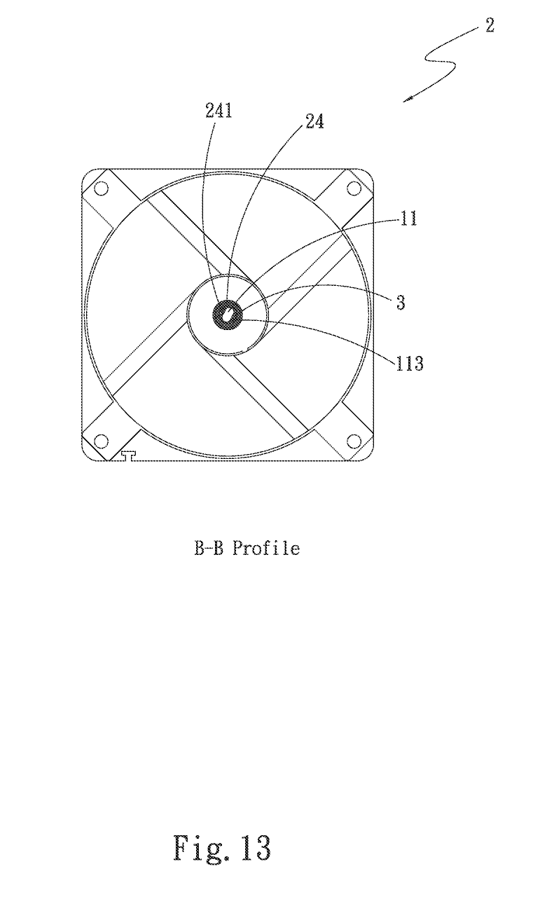

Please refer to FIG. 13 that is a sectional view taken along line B-B of FIG. 8, which is an assembled perspective view of the first embodiment of the cooling fan 1 according to the present invention. As shown in FIG. 13, the main body 11 is received in the shaft space 241 of the bearing 24 with the peripheral surface 113 of the main body 11 facing toward an inner wall surface of the shaft space 241. Since the main body 11 has a non-circular cross section, the lubricant 3 filled in the space left between the peripheral surface 113 of the rotor shaft 1 and the shaft space 241 can have increased support pressure. With these arrangements, the main body 11 is present in the shaft space 241 of the bearing 24 in a suspended state without colliding against the inner wall surface of the shaft space 241 when the cooling fan 2 operates. In this manner, the noise, vibration and frictional wearing produced during the operation of the cooling fan 2 can be reduced to largely increase the service life of the cooling fan 2.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A rotor shaft, comprising a main body having a central portion and an extension portion; the extension portion including a plurality of extension sections, and the extension sections being connected to one another and respectively radially outward extending from the central portion to together define a peripheral surface of the main body; and wherein the extension sections respectively radially outward extend from the central portion by a different distance.

2. The rotor shaft as claimed in claim 1, wherein the extension portion includes a first extension section, a second extension section, a third extension section, and a fourth extension section; the first and the second extension section being located diametrically opposite to each other, and the third and the fourth extension section being located diametrically opposite to each other, such that the first extension section has two lateral sides adjoining to one lateral side of the third and of the fourth extension while the second extension section has two lateral sides adjoining to the other lateral side of the third and of the fourth extension; and wherein the main body has an elliptical cross section.

3. The rotor shaft as claimed in claim 1, wherein the extension portion includes a first extension section, a second extension section, and a third extension section; the first extension section having two lateral sides separately adjoining to the second and the third extension section; and wherein the main body has a rounded wedge-shaped cross section.

4. The rotor shaft as claimed in claim 1, wherein the main body has a non-circular cross section.

5. The rotor shaft as claimed in claim 1, wherein the main body further has a first extended end, which is axially extended from an end of the main body and has a round cross section.

6. The rotor shaft as claimed in claim 1, wherein the main body further has a first extended end and a second extended end, which are separately axially extended from two opposite ends of the main body and both have a round cross section.

7. The rotor shaft as claimed in claim 1, wherein the main body further has a first extended end and a second extended end; the first extended end being axially extended from an end of the main body and having a round cross section, and the second extended end being axially extended from an end of the first extended end opposite to the main body and having a cross-sectional shape the same as that of the main body.

8. A cooling fan, comprising:
a seat having a bearing cup internally defining a receiving space, and the receiving space axially extending a full length of the bearing cup;
a stator assembly being mounted around the bearing cup;
a bearing internally defining a shaft space, and being received in the receiving space of the bearing cup;
a rotor assembly having a hub and a rotor shaft; the hub having a plurality of blades spaced thereon; the rotor shaft having an end inserted into one side of the hub and another opposite end rotatably received in the shaft space; the rotor shaft having a main body, which includes a central portion and an extension portion; the extension portion including a plurality of extension sections, and the extension sections being connected to one another and respectively radially outward extending from the central portion to together define a peripheral surface of the main body; the extension sections respectively radially outward extending from the central portion by a different distance; and a lubricant being filled in a space left between the peripheral surface of the main body and the shaft space.

9. The cooling fan as claimed in claim 8, wherein the extension portion of the rotor shaft includes a first extension section, a second extension section, a third extension section, and a fourth extension section; the first and the second extension section being located diametrically opposite to each other, and the third and the fourth extension section being located diametrically opposite to each other, such that the first extension section has two lateral sides adjoining to one lateral side of the third and of the fourth extension while the second extension section has two lateral sides adjoining to the other lateral side of the third and of the fourth extension; and wherein the main body of the rotor shaft has an elliptical cross section.

10. The cooling fan as claimed in claim 8, wherein the extension portion of the rotor shaft includes a first extension section, a second extension section, and a third extension section; the first extension section having two lateral sides separately adjoining to the second and the third extension section; and wherein the main body of the rotor shaft has a rounded wedge-shaped cross section.

11. The cooling fan as claimed in claim 8, wherein the main body of the rotor shaft has a non-circular cross section.

12. The cooling fan as claimed in claim 8, wherein a lubricant is present between the shaft space and the main body.

13. The cooling fan as claimed in claim 8, wherein the stator assembly includes a plurality of coils and at least one silicon steel plate, and the coils being externally wound around the silicon steel plate.

14. The cooling fan as claimed in claim 8, wherein the stator assembly includes a plurality of coils and a magnetizable metal member, and the coils being externally wound around the magnetizable metal member.

15. The cooling fan as claimed in claim 8, wherein the stator assembly includes a plurality of coils and a circuit board, and the coils being wound on the circuit board.
